(19) United States
(12) Patent Application Publication
(10) Pub. No.: US 2022/0269909 A1
(43) Pub. Date: Aug. 25, 2022

(54) INFORMATION PROCESSING APPARATUS, INFORMATION PROCESSING METHOD, AND COMPUTER PROGRAM

(71) Applicant: NEC Corporation, Minato-ku, Tokyo (JP)

(72) Inventors: Akinori Ebihara, Tokyo (JP); Taiki Miyagawa, Tokyo (JP)

(73) Assignee: NEC Corporation, Minato-ku, Tokyo (JP)

(21) Appl. No.: 17/637,180

(22) PCT Filed: Sep. 11, 2020
(86) PCT No.: PCT/JP2020/034545

§ 371 Date: Feb. 22, 2022

(51) Int. Cl. G06K 9/62

(52) U.S. Cl. CPC G06K 9/6268; G06K 9/628

(57) ABSTRACT

An information processing apparatus (10) includes: an acquisition unit (50) configured to sequentially acquire a plurality of elements included in sequential data; a calculation unit (100) configured to calculate, based on at least two elements of the plurality of elements, a classification indicator indicating which one of a plurality of classes the sequential data belongs to; a processing unit (200) configured to execute either a first process of resetting the classification indicator to a predetermined value, or a second process of establishing a new thread to calculate the classification indicator; and a determination unit (300) configured to determine an interval including an element of a detection-target class, based on the classification indicator. According to such an information processing apparatus, an interval including elements of the detection-target class can be appropriately determined.

### TECHNICAL FIELD

The present disclosure relates to a technical field of an information processing apparatus, an information processing method, and a computer program that process information, for example, used for classification.

### BACKGROUND ART

As a system of this type, there is known a system that determines an interval in which specific data exists, in sequential data. For example, Patent Reference 1 discloses a technique that extracts an interval in which identical labels are consecutive, and identifies, in a data string, an interval of data corresponding to each of the labels.

As other related techniques, for example, Patent Reference 2 discloses that when class likelihoods temporally continue to exceed a predetermined threshold value, the class likelihood calculated by each class filter is adopted and outputted, and otherwise a predetermined fixed value is adopted and outputted. Patent Reference 3 discloses that when two types of discrete values, namely, a label of +1 indicating a detection target and a label of -1 indicating a non-detection target, are outputted, a value of a ratio between probability values (likelihood ratio), or a logarithm of the likelihood ratio (logarithmic likelihood ratio), may be outputted.

### CITATION LIST

### Patent Literature

### Patent Reference 1

Japanese Patent Laid-Open No. 2018-136589 A

### Patent Reference 2

Japanese Patent Laid-Open No. 2009-204418 A

### Patent Reference 3

### SUMMARY

### Technical Problem

The present disclosure improves the related techniques described above.

### Solution to Problem

An information processing apparatus according to an example aspect of the present invention includes: an acquisition unit configured to sequentially acquire a plurality of elements included in sequential data; a calculation unit configured to calculate, based on at least two elements of the plurality of elements, a classification indicator indicating which one of a plurality of classes the sequential data belongs to; a processing unit configured to execute either a first process of resetting the classification indicator to a predetermined value when a predetermined condition is satisfied, or a second process of establishing a new thread to calculate the classification indicator; and a determination unit configured to determine an interval including an element of a detection-target class in the sequential data, based on the classification indicator.

An information processing method according to an example aspect of the present invention includes: sequentially acquiring a plurality of elements included in sequential data; calculating, based on at least two elements of the plurality of elements, a classification indicator indicating which one of a plurality of classes the sequential data belongs to; executing either a first process of resetting the classification indicator to a predetermined value when a predetermined condition is satisfied, or a second process of establishing a new thread to calculate the classification indicator; and determining an interval including an element of a detection-target class in the sequential data, based on the classification indicator.

A computer program according to an example aspect of the present invention allows a computer to: sequentially acquire a plurality of elements included in sequential data; calculate, based on at least two elements of the plurality of elements, a classification indicator indicating which one of a plurality of classes the sequential data belongs to; execute either a first process of resetting the classification indicator to a predetermined value when a predetermined condition is satisfied, or a second process of establishing a new thread to calculate the classification indicator; and determine an interval including an element of a detection-target class in the sequential data, based on the classification indicator.

### BRIEF DESCRIPTION OF DRAWINGS

FIG. 1 is a block diagram showing a hardware configuration of an information processing apparatus according to a first embodiment.

FIG. 2 is a block diagram showing a functional configuration of the information processing apparatus according to the first embodiment.

FIG. 3 is a flowchart (version 1) showing a flow of operation of the information processing apparatus according to the first embodiment.

FIG. 4 is a flowchart (version 2) showing a flow of operation of the information processing apparatus according to the first embodiment.

FIG. 5 is a flowchart showing a flow of an interval determination process in an information processing apparatus according to a second embodiment.

FIG. 6 is a graph showing an example of the interval determination process when a first threshold value is equal to a second threshold value.

FIG. 7 is a graph showing an example of the interval determination process when the first threshold value is higher than the second threshold value.

FIG. 8 is a graph showing an example of the interval determination process when the first threshold value is lower than the second threshold value.

FIG. 9 is a flowchart showing a flow of operation of an information processing apparatus according to a third embodiment.

FIG. 10 is a flowchart showing a flow of operation of an information processing apparatus according to a modification of the third embodiment.

FIG. 11 is a graph showing an example of changes in a classification indicator in the information processing apparatus according to the modification of the third embodiment.

FIG. 12 is a flowchart showing a flow of operation of an information processing apparatus according to a fourth embodiment.

FIG. 13 is a flowchart showing a flow of operation of an information processing apparatus according to a modification of the fourth embodiment.

FIG. 14 is a graph showing an example of changes in the classification indicator in the information processing apparatus according to the modification of the fourth embodiment.

FIG. 15 is a flowchart showing a flow of operation of an information processing apparatus according to a fifth embodiment.

FIG. 16 is a graph showing an example of changes in the classification indicator in the information processing apparatus according to the fifth embodiment.

FIG. 17 is a flowchart showing a flow of operation of an information processing apparatus according to a sixth embodiment.

FIG. 18 is a graph showing an example of changes in the classification indicator in the information processing apparatus according to the sixth embodiment.

FIG. 19 is a block diagram showing a functional configuration of an information processing apparatus according to a seventh embodiment.

FIG. 20 is a flowchart showing a flow of an indicator calculation process in the information processing apparatus according to the seventh embodiment.

### DESCRIPTION OF EXAMPLE EMBODIMENTS

Hereinafter, embodiments of an information processing apparatus, an information processing method, and a computer program will be described with reference to drawings.

### First Embodiment

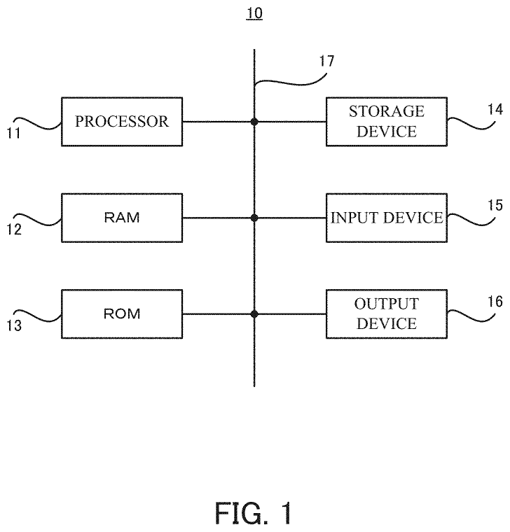

An information processing apparatus according to a first embodiment is described with reference to FIGS. 1 to 4.

### (Hardware Configuration)

First, a hardware configuration of the information processing apparatus according to the first embodiment is described with reference to FIG. 1. FIG. 1 is a block diagram showing the hardware configuration of the information processing apparatus according to the first embodiment.

As shown in FIG. 1, the information processing apparatus 10 according to the first embodiment includes a processor 11, a RAM (Random Access Memory) 12, a ROM (Read Only Memory) 13, and a storage device 14. The information processing apparatus 10 may further include an input device 15 and an output device 16. The processor 11, the RAM 12, the ROM 13, the storage device 14, the input device 15, and the output device 16 are connected to each other through a data bus 17.

The processor 11 reads a computer program. For example, the processor 11 is configured to read the computer program stored in at least one of the RAM 12, the ROM 13, and the storage device 14. Alternatively, the processor 11 may read the computer program stored in a computer-readable recording medium, by using an undepicted a recording media reader. The processor 11 may acquire (that is, may read) the computer program, via a network interface, from an undepicted device disposed outside of the information processing apparatus 10. The processor 11 controls the RAM 12, the storage device 14, the input device 15, and the output device 16 by executing the read computer program. In the present embodiment in particular, when the processor 11 executes the read computer program, a functional block for determining an interval in which data belonging to a specific class exists, is implemented in the processor 11. Moreover, for the processor 11, one of a CPU (Central Processing Unit), a GPU (Graphics Processing Unit), an FPGA (field-programmable gate array), a DSP (Demand-Side platform), and an ASIC (Application Specific Integrated Circuit) may be used, or two or more thereof may be used in parallel.

The RAM 12 transitorily stores the computer program to be executed by the processor 11. The RAM 12 transitorily stores data transitorily used by the processor 11 when the processor 11 executes the computer program. The RAM 12 may be, for example, a D-RAM (Dynamic RAM).

The ROM 13 stores the computer program to be executed by the processor 11. The ROM 13 may store other fixed data. The ROM 13 may be, for example, a P-ROM (Programmable ROM).

The storage device 14 stores data that the information processing apparatus 10 retains for a long time. The storage device 14 may operate as a transitory storage device for the processor 11. The storage device 14 may include at least one of, for example, a hard disk device, a magneto-optical device, an SSD (Solid State Drive), and a disk array device.

The input device 15 is a device that receives an input instruction from a user of the information processing apparatus 10. The input device 15 may include at least one of, for example, a keyboard, a mouse, and a touch panel.

The output device 16 is a device that outputs information related to the information processing apparatus 10 to the outside. For example, the output device 16 may be a display device (for example, a display) capable of displaying the information related to the information processing apparatus 10.

### (Functional Configuration)

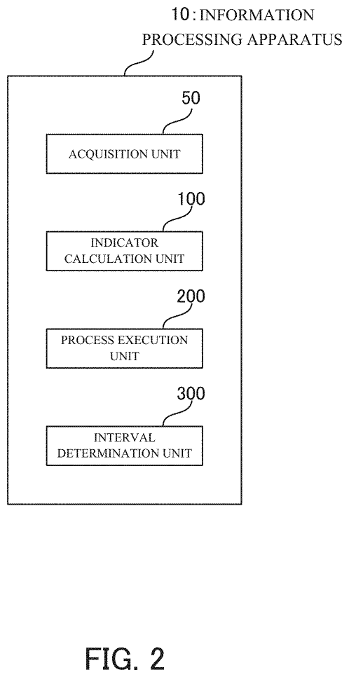

Next, a functional configuration of the information processing apparatus 10 according to the first embodiment is described with reference to FIG. 2. FIG. 2 is a block diagram showing the functional configuration of the information processing apparatus according to the first embodiment.

As shown in FIG. 2, the information processing apparatus 10 according to the first embodiment includes, as processing blocks for implementing functions of the information processing apparatus 10, an acquisition unit 50, an indicator calculation unit 100, a process execution unit 200, and an interval determination unit 300. Note that each of the acquisition unit 50, the indicator calculation unit 100, the process execution unit 200, and the interval determination unit 300 may be implemented by the above-described processor 11 (see FIG. 1).

The acquisition unit 50 is configured to be able to sequentially acquire a plurality of elements included in sequential data. For example, the acquisition unit 50 acquires the plurality of elements one by one. The acquisition unit 50 may acquire the data directly from an arbitrary data acquisition device (for example, a camera or the like), or may read the data acquired in advance by a data acquisition device and stored in a storage or the like. A configuration is made such that each element of the sequential data acquired by the acquisition unit 50 is outputted to the indicator calculation unit 100.

The indicator calculation unit 100 is configured to be able to calculate a classification indicator, based on at least two elements of the plurality of elements acquired by the acquisition unit 50. For example, the indicator calculation unit 100 calculates the classification indicator, based on two elements consecutively acquired by the acquisition unit 50. Note that the “classification indicator” here refers to an indicator indicating which one of a plurality of classes the sequential data belongs to. Specific examples of the classification indicator and a specific calculation method are described in detail in other embodiments, which will be described later. A “class” may be one relating to “true” or “false” of an event of an object, or may be one relating to “presence” or “absence” of a specific attribute of an object. A class may be one relating to “positive” or “negative” of a state of an object. For example, a class may indicate whether a face of a person is real (true) or is disguised (masquerade) with a mask or the like (false). In another example, a class may indicate whether a person wears any accessory (presence) or does not (absence). In still another example, a class may be one relating to whether a person is in a good health condition (positive) or in a bad health condition (negative). However, the classes are not limited to the above-described examples.

The process execution unit 200 is configured to be able to execute a first process or a second process that are processes related to the classification indicator. The first process is a process of resetting the classification indicator to a predetermined value (that is, forcefully changing the classification indicator to the predetermined value) when a predetermined condition is satisfied. Specific examples of the predetermined condition and the predetermined value, as well as a setting method, are described in detail in the embodiments described later. On the other hand, the second process is a process of establishing a new thread for the acquisition unit 50 to calculate the classification indicator (in other words, a new calculation process). The process execution unit 200 may be configured to be able to execute only any one of the first process or the second process. Alternatively, the process execution unit 200 may be configured to be able to selectively switch between the first process and the second process and execute the first process or the second process. In such a case, a configuration may be made such that a system administrator or the like can set as appropriate which one of the first process and the second process is executed.

The interval determination unit 300 is configured to be able to determine an interval including elements of a detection-target class in the sequential data, based on the classification indicator calculated by the indicator calculation unit 100, or on the classification indicator obtained as a result of the process by the process execution unit 200. The “detection-target class” here refers to one or more classes that are included in the plurality of classes, and is preset as a target to be detected by the information processing apparatus 10. For example, the detection-target class may be set by the system administrator or the like. The interval determination unit 300 determines the interval including elements of the detection-target class, for example, by determining whether the calculated classification indicator is a value corresponding to the detection-target class, or a value corresponding to a class other than the detection-target class. The interval determination unit 300 may determine the interval including elements of the detection-target class by detecting a beginning point of the interval including the elements of the detection-target class, or an end point of the interval including the elements of the detection-target class. More specific content of the process by the interval determination unit 300 is described in detail in the embodiments described later.

### (Operation in Case of Executing First Process)

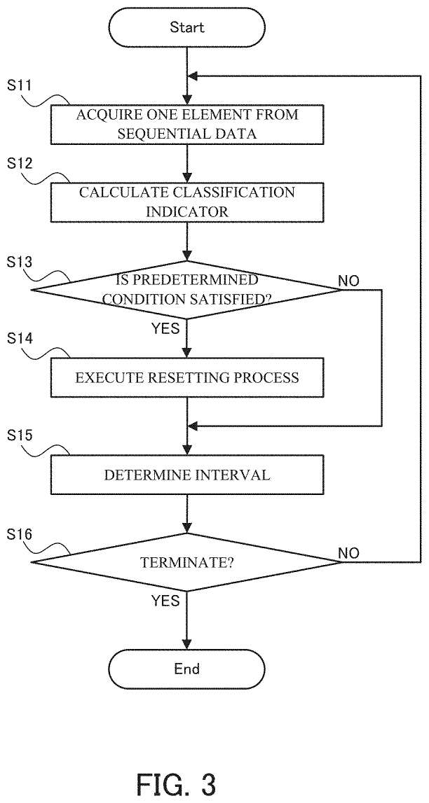

Next, a flow of operation of the information processing apparatus 10 according to the first embodiment (particularly, operation when the process execution unit 200 executes the first process) is described with reference to FIG. 3. FIG. 3 is a flowchart (version 1) showing the flow of the operation of the information processing apparatus according to the first embodiment.

As shown in FIG. 3, when the information processing apparatus 10 according to the first embodiment starts to operate, first, the acquisition unit 50 acquires one element from sequential data (step S11). The acquisition unit 50 outputs the acquired element of the sequential data to the indicator calculation unit 100. The indicator calculation unit 100 calculates a classification indicator, based on two or more elements thus acquired (step S12).

Subsequently, the process execution unit 200 determines whether or not the predetermined condition is satisfied (step S13). When it is determined that the predetermined condition is satisfied (step S13: YES), the process execution unit 200 executes the process of resetting the classification indicator to the predetermined value (that is, the first process) (step S14). When it is determined that the predetermined condition is not satisfied (step S13: NO), the process execution unit 200 omits the process in step S14 (that is, the first process is not executed).

Subsequently, the interval determination unit 300 determines an interval, based on the classification indicator (step S15). At the time, the interval determination unit 300 may output a result of the determination (for example, information related to the interval including elements of the detection-target class). For example, the result of the determination may be outputted by the above-mentioned output device 16 (see FIG. 1). For example, the result of the determination may be displayed on a display, or may be outputted as audio.

Subsequently, the information processing apparatus 10 according to the first embodiment determines whether or not to terminate the above-described series of processes (step S16). The information processing apparatus 10 may determine to terminate the series of processes, for example, when all elements of the sequential data are acquired, or when the number of loops of the series of processes reaches a predetermined number, or the like. When it is determined to terminate the processes (step S16: YES), the series of processes is terminated. When it is determined not to terminate the processes (step S16: NO), the processes are started again from step S11.

### (Operation in Case of Executing Second Process)

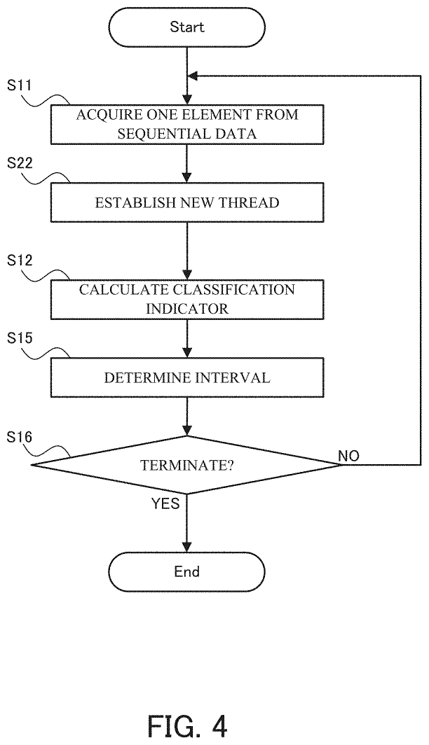

Next, a flow of operation of the information processing apparatus 10 according to the first embodiment (particularly, operation when the process execution unit 200 executes the second process) is described with reference to FIG. 4. FIG. 4 is a flowchart (version 2) showing the flow of the operation of the information processing apparatus according to the first embodiment. Note that in FIG. 4, processes similar to the processes shown in FIG. 3 are denoted by the same reference numbers as in FIG. 3.

As shown in FIG. 4, when the information processing apparatus 10 according to the first embodiment starts to operate, first, the acquisition unit 50 acquires one element from sequential data (step S11). Then, the process execution unit 200 executes the process of establishing a new thread to calculate a classification indicator (that is, the second process) (step S22).

Subsequently, the indicator calculation unit 100 calculates the classification indicator, based on two or more elements thus acquired (step S12).

Subsequently, the interval determination unit 300 determines an interval, based on the classification indicator (step S15). At the time, the interval determination unit 300 may output a result of the determination (for example, information related to the interval including elements of the detection-target class). For example, the result of the determination may be outputted by the above-mentioned output device 16 (see FIG. 1). For example, the result of the determination may be displayed on a display, or may be outputted as audio.

Subsequently, the information processing apparatus 10 according to the first embodiment determines whether or not to terminate the above-described series of processes (step S16). The information processing apparatus 10 may determine to terminate the series of processes, for example, when all elements of the sequential data are acquired, or when the number of loops of the series of processes reaches a predetermined number, or the like. When it is determined to terminate the processes (step S16: YES), the series of processes is terminated. When it is determined not to terminate the processes (step S16: NO), the processes are started again from step S11.

### (Technical Effects)

Next, technical effects achieved by the information processing apparatus 10 according to the first embodiment are described.

As described in FIGS. 1 to 4, in the information processing apparatus 10 according to the first embodiment, an interval including elements of the detection-target class is determined based on the classification indicator. Here, the classification indicator according to the present embodiment, in particular, is calculated based on two or more elements. Accordingly, when a situation continues in which only a specific element is acquired, resultant values lean to the specific element side. In a state where the classification indicator greatly leans to the specific element side, there is a possibility that presence of another element cannot be detected even if such other elements are acquired in some part. In other words, the classification indicator greatly leaning to the specific element side does not sufficiently work for the other element side, so that it possibly cannot be detected that other elements are acquired. In such a case, an interval including elements of the detection-target class cannot be appropriately determined based on the classification indicator.

However, in the information processing apparatus 10 according to the first embodiment, as described above, the first process or the second process is executed, depending on the condition. When the first process is executed, since the classification indicator is reset to the predetermined value, the classification indicator can be prevented from greatly leaning to the specific element side. On the other hand, when the second process is executed, since calculation is started with a new thread, the classification indicator can be calculated without being affected by past results of the calculation (that is, an effect similar to the effect of the first process, in which the classification indicator is reset, can be achieved). As a result, according to the information processing apparatus 10 in the first embodiment, an interval including elements of the detection-target class can be appropriately determined.

### Second Embodiment

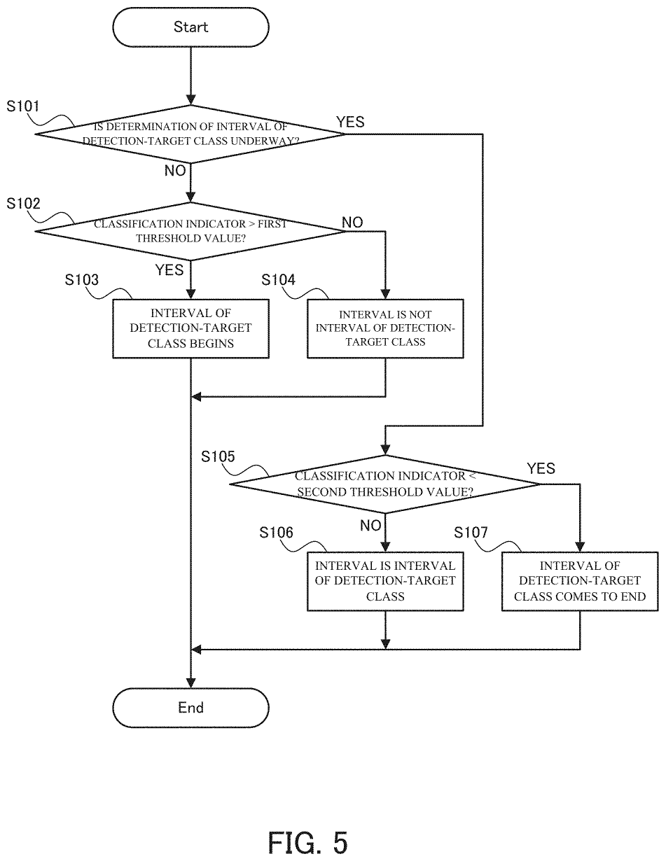

An information processing apparatus 10 according to a second embodiment is described with reference to FIGS. 5 to 8. The second embodiment is to specifically describe the details of the process by the interval determination unit 300, and a system configuration and a flow of entire operation may be similar to those of the first embodiment (see FIGS. 1 to 4). Accordingly, in the following, part different from the first embodiment is described in detail, and a description of other overlapping part is omitted as appropriate.

### (Flow of Interval Determination Process)

First, a flow of an interval determination process (that is, the process in step S15 in FIGS. 3 and 4) in the information processing apparatus 10 according to the second embodiment is described with reference to FIG. 5. FIG. 5 is a flowchart showing the flow of the interval determination process in the information processing apparatus according to the second embodiment.

As shown in FIG. 5, the interval determination unit 300 first determines whether or not determination of an interval including elements of the detection-target class is already underway (step S101). For example, the interval determination unit 300 may store a result of the previous determination, and may determine whether or not determination of an interval including elements of the detection-target class is already underway. For example, the result of the previous determination may be managed based on whether a flag is on or off, or the like.

When determination of an interval including elements of the detection-target class is not already underway (step S101: NO), the interval determination unit 300 determines whether or not the classification indicator exceeds a first threshold value (step S102). The “first threshold value” here is a threshold value for determining a beginning point of an interval including elements of the detection-target class, and is preset, for example, by the system administrator or the like. When the classification indicator exceeds the first threshold value (step S102: YES), the interval determination unit 300 determines that an interval including elements of the detection-target class begins (step S103). In other words, it is determined that the preceding interval is not an interval including elements of the detection-target class, but an interval including elements of the detection-target class begins. When the classification indicator does not exceed the first threshold value (step S102: NO), the interval determination unit 300 determines that an interval including elements of the detection-target class does not yet begin (step S104). In other words, it is determined that an interval including elements of a class other than the detection-target class continues.

In contrast, when determination of an interval including elements of the detection-target class is already underway (step S101: YES), the interval determination unit 300 determines whether or not the classification indicator falls below a second threshold value (step S105). The “second threshold value” here is a threshold value for determining an end point of the interval including elements of the detection-target class, and is preset, for example, by the system administrator or the like. When the classification indicator does not fall below the second threshold value (step S105: NO), the interval determination unit 300 determines that the interval is still the interval including elements of the detection-target class (step S106). In other words, it is determined that the interval including elements of the detection-target class continues. When the classification indicator falls below the second threshold value (step S105: YES), the interval determination unit 300 determines that the interval including elements of the detection-target class comes to an end (step S107). In other words, it is determined that although the preceding interval is the interval including elements of the detection-target class, an interval including elements of a class other than the detection-target class begins.

### (Specific Examples of Interval Determination Process)

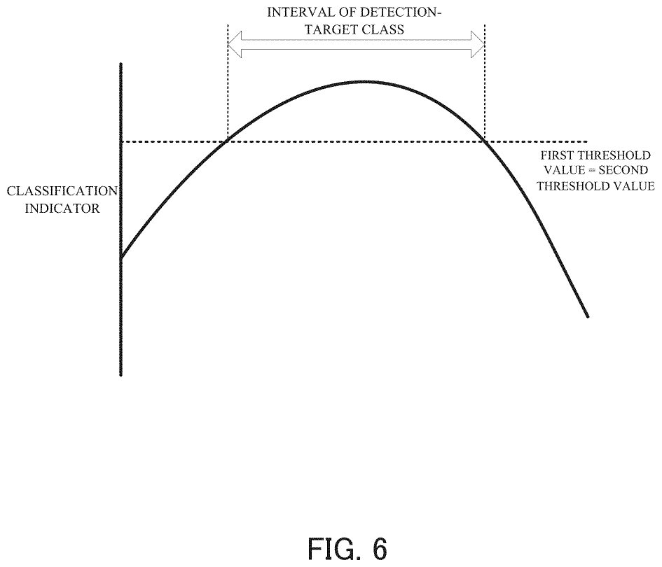

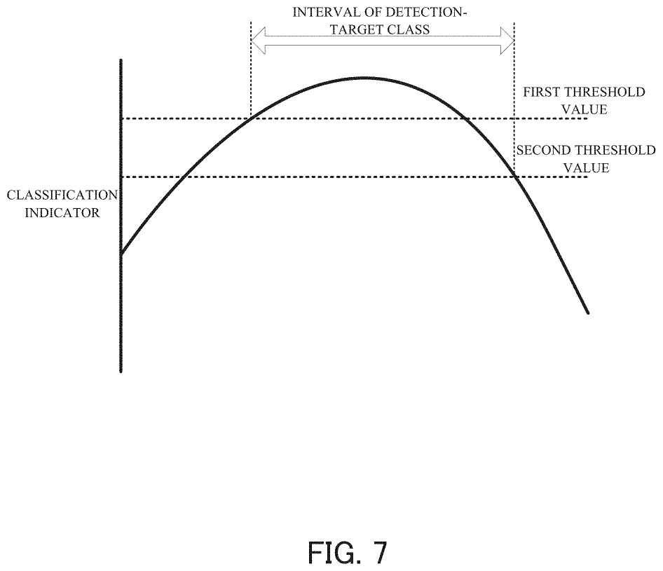

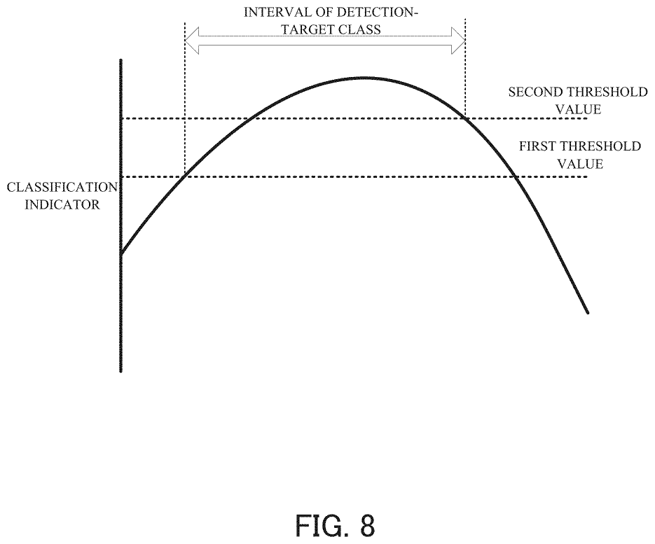

Next, specific examples of determination in the above-described interval determination process are described with reference to FIGS. 6 to 8. FIG. 6 is a graph showing an example of the interval determination process when the first threshold value is equal to the second threshold value. FIG. 7 is a graph showing an example of the interval determination process when the first threshold value is higher than the second threshold value. FIG. 8 is a graph showing an example of the interval determination process when the first threshold value is lower than the second threshold value.

As shown in FIG. 6, the first threshold value and the second threshold value may be set to mutually equal values. In such a case, the interval determination unit 300 determines that a point where the classification indicator exceeds the first threshold value is a beginning point of an interval including elements of the detection-target class. The interval determination unit 300 then determines that a point where the classification indicator falls below the second threshold value, which is equal to the first threshold value, is an end point of the interval including elements of the detection-target class.

As shown in FIG. 7, the first threshold value may be set to a value that is higher than the second threshold value. In such a case, the interval determination unit 300 determines that a point where the classification indicator exceeds the second threshold value and further exceeds the first threshold value is a beginning point of an interval including elements of the detection-target class. The interval determination unit 300 then determines that a point where, after falling blow the first threshold value, the classification indicator falls below the second threshold value, which is lower than the first threshold value, is an end point of the interval including elements of the detection-target class.

As shown in FIG. 8, the first threshold value may be set to a value that is lower than the second threshold value. In such a case, the interval determination unit 300 determines that a point where the classification indicator exceeds the first threshold value is a beginning point of an interval including elements of the detection-target class. The interval determination unit 300 then determines that a point where the classification indicator falls below the second threshold value, which is higher than the first threshold value, is an end point of the interval including elements of the detection-target class. In other words, the interval determination unit 300 determines that the interval including elements of the detection-target class comes to an end before the classification indicator falls below the first threshold value.

### (Technical Effects)

Next, technical effects achieved by the information processing apparatus 10 according to the second embodiment are described.

As described in FIGS. 5 to 8, in the information processing apparatus 10 according to the second embodiment, an interval including elements of the detection-target class is determined by comparing the classification indicator to the first threshold value and the second threshold value. By using two different threshold values as described above, a beginning point and an end point of an interval including elements of the detection-target class can be appropriately detected individually (see FIGS. 7 and 8). Accordingly, an interval including elements of the detection-target class can be detected with higher accuracy. Note that if the first threshold value and the second threshold value are set to equal values (see FIG. 6), the interval determination process can be simplified. For example, when the first threshold value and the second threshold value are mutually equal values, case-splitting through the determination process in step S101, shown in the flowchart of FIG. 5, is eliminated.

### Third Embodiment

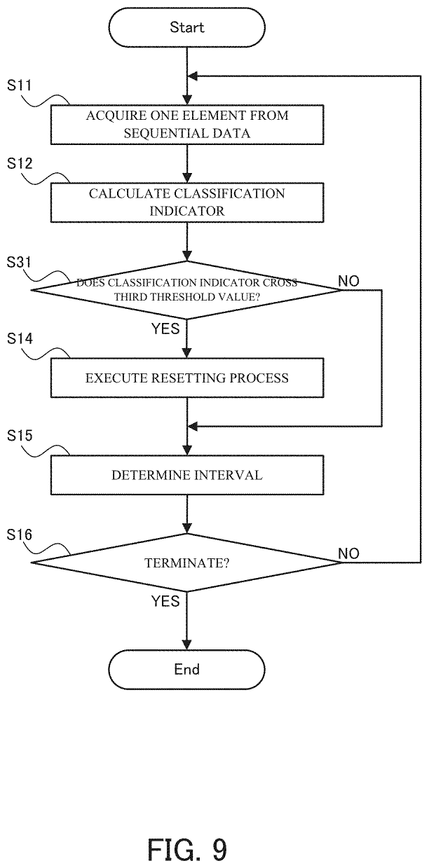

An information processing apparatus 10 according to a third embodiment is described with reference to FIGS. 9 to 11. Note that the third embodiment is different from the above-described first and second embodiments only in part of operation, and other operation and a system configuration may be similar to those of the first and second embodiments. Accordingly, in the following, the part different from the first and second embodiments is described in detail, and a description of other overlapping part is omitted as appropriate.

### (Flow of Operation)

First, a flow of operation of the information processing apparatus 10 according to the third embodiment is described with reference to FIG. 9. FIG. 9 is a flowchart showing the flow of the operation of the information processing apparatus according to the third embodiment. Note that in FIG. 9, processes similar to the processes shown in FIG. 3 are denoted by the same reference numbers as in FIG. 3.

As shown in FIG. 9, when the information processing apparatus 10 according to the third embodiment starts to operate, first, the acquisition unit 50 acquires one element from sequential data (step S11). The acquisition unit 50 outputs the acquired element of the sequential data to the indicator calculation unit 100. The indicator calculation unit 100 calculates a classification indicator, based on two or more elements thus acquired (step S12).

Subsequently, the process execution unit 200 determines whether or not the classification indicator calculated by the indicator calculation unit 100 crosses a third threshold value (step S31). In other words, in the information processing apparatus 10 according to the third embodiment, it is set as a predetermined condition that the classification indicator crosses the third threshold value. Note that the “third threshold value” is a threshold value to determine that the classification indicator greatly leans to a side to a class other than the detection-target class. For example, the third threshold value may be set as a value that can determine a state in which the classification indicator leans to such an extent that the sequential data can be classified as the class other than the detection-target class.

When it is determined that the classification indicator crosses the third threshold value (step S31: YES), the process execution unit 200 executes the process of resetting the classification indicator to the predetermined value (that is, the first process) (step S14). When it is determined that the classification indicator does not cross the third threshold value (step S31: NO), the process execution unit 200 omits the process in step S14 (that is, the first process is not executed).

Subsequently, the interval determination unit 300 determines an interval, based on the classification indicator (step S15). Then, the information processing apparatus 10 according to the third embodiment determines whether or not to terminate the above-described series of processes (step S16). When it is determined to terminate the processes (step S16: YES), the series of processes is terminated. When it is determined not to terminate the series of processes (step S16: NO), the processes are started again from step S11.

### (Technical Effects)

Next, technical effects achieved by the information processing apparatus 10 according to the third embodiment are described.

As described in FIG. 9, in the information processing apparatus 10 according to the third embodiment, when the classification indicator crosses the third threshold value, the first process (that is, the process of resetting the classification indicator to the predetermined value) is executed. With the configuration thus made, even if the classification indicator greatly leans to a side to a class other than the detection-target class, such a state can be resolved through the first process. Accordingly, when an interval including elements of the detection-target class begins, the classification indicator smoothly changes to values on the detection-target class side. Accordingly, according to the information processing apparatus 10 in the third embodiment, an interval including elements of the detection-target class can be appropriately determined.

### (Modification of Third Embodiment)

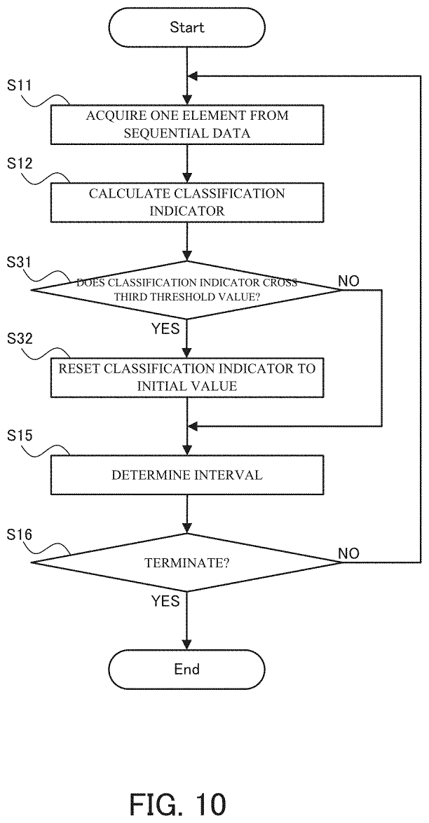

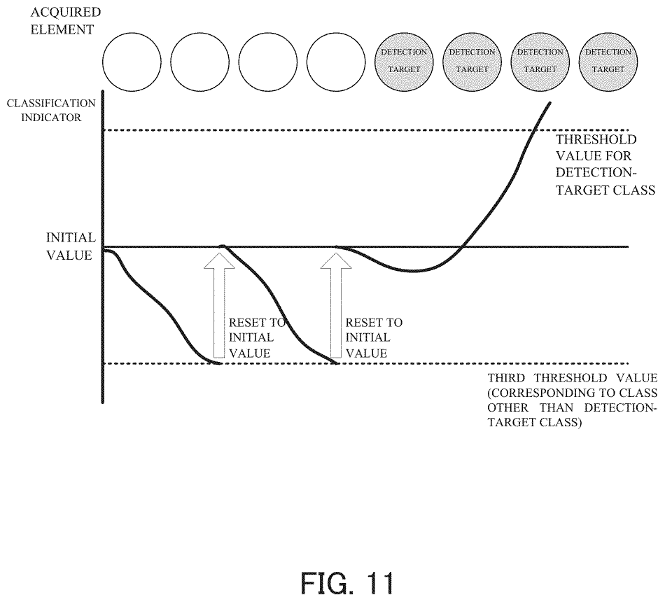

Next, an information processing apparatus 10 according to a modification of the third embodiment is described with reference to FIGS. 10 and 11. Note that the information processing apparatus 10 according to the modification of the third embodiment is different from the above-described third embodiment only in part of operation, and other operation and a system configuration may be similar to those of the third embodiment. Accordingly, in the following, the part different from the already described third embodiment is described in detail, and a description of other overlapping part is omitted as appropriate.

### (Flow of Operation)

First, a flow of operation of the information processing apparatus 10 according to the modification of the third embodiment is described with reference to FIG. 10. FIG. 10 is a flowchart showing the flow of the operation of the information processing apparatus according to the modification of the third embodiment. Note that in FIG. 10, processes similar to the processes shown in FIG. 9 are denoted by the same reference numbers as in FIG. 9.

As shown in FIG. 10, when the information processing apparatus 10 according to the modification of the third embodiment starts to operate, first, the acquisition unit 50 acquires one element from sequential data (step S11). The acquisition unit 50 outputs the acquired element of the sequential data to the indicator calculation unit 100. The indicator calculation unit 100 calculates a classification indicator, based on two or more elements thus acquired (step S12).

Subsequently, the process execution unit 200 determines whether or not the classification indicator calculated by the indicator calculation unit 100 crosses the third threshold value (step S31). When it is determined that the classification indicator crosses the third threshold value (step S31: YES), the process execution unit 200 executes the process of resetting the classification indicator to an initial value (for example, zero) (step S32). In other words, in the modification of the third embodiment, the predetermined value is set to an initial value of the classification indicator. When it is determined that the classification indicator does not cross the third threshold value (step S31: NO), the process execution unit 200 omits the process in step S32 (that is, the first process is not executed).

Subsequently, the interval determination unit 300 determines an interval, based on the classification indicator (step S15). Then, the information processing apparatus 10 according to the modification of the third embodiment determines whether or not to terminate the above-described series of processes (step S16). When it is determined to terminate the processes (step S16: YES), the series of processes is terminated. When it is determined not to terminate the processes (step S16: NO), the processes are started again from step S11.

### (Example of Changes in Classification Indicator)

Next, it is described specifically with reference to FIG. 11 how the classification indicator changes in the information processing apparatus 10 according to the modification of the third embodiment. FIG. 11 is a graph showing an example of changes in the classification indicator in the information processing apparatus according to the modification of the third embodiment.

In the example shown in FIG. 11, elements of a class other than the detection-target class are acquired first (see white circles in the drawing), and elements of the detection-target class are acquired thereafter. In such a case, the classification indicator first changes toward the third threshold value (that is, a lower side of the graph) corresponding to the other class than the detection-target class. However, when the classification indicator crosses the third threshold value (becomes lower than the third threshold value), the first process is executed, so that the classification indicator is reset to the initial value. Accordingly, in the example shown in FIG. 11, in an interval where elements of the other class than the detection-target class are consecutive, the classification indicator is reset to the initial value twice.

Thereafter, when an element of the detection-target class element starts to be acquired, the classification indicator changes toward the threshold value for the detection-target class (for example, the first threshold value or the second threshold value in the second embodiment). In such a situation, if the classification indicator greatly leaned to the third threshold value side without being reset to the initial value, the classification indicator would take a long time to exceed the threshold value for the detection-target class even in a state where elements of the detection-target class are acquired. Moreover, if an interval where elements of the detection-target class are consecutive was relatively short, there would be a possibility that the classification indicator does not exceed the threshold value for the detection-target class even once. However, in the example shown in FIG. 11, since the classification indicator is reset to the initial value each time the classification indicator crosses the third threshold value, the classification indicator exceeds the threshold value for the detection-target class relatively early on.

### (Technical Effects)

Next, technical effects achieved by the information processing apparatus 10 according to the modification of the third embodiment are described.

As described in FIGS. 10 and 11, in the information processing apparatus 10 according to the modification of the third embodiment, when the classification indicator crosses the third threshold value, the process of resetting the classification indicator to the initial value is executed. With the configuration thus made, the classification indicator is reset to the initial value when the classification indicator greatly leans to a side to a class other than the detection-target class.

When the classification indicator becomes the initial value, the situation in which the classification indicator leans to the side to the other class than the detection-target class is reliably resolved. Accordingly, according to the information processing apparatus 10 in the modification of the third embodiment, an interval including elements of the detection-target class (particularly, a beginning point of the interval) can be appropriately determined.

### Fourth Embodiment

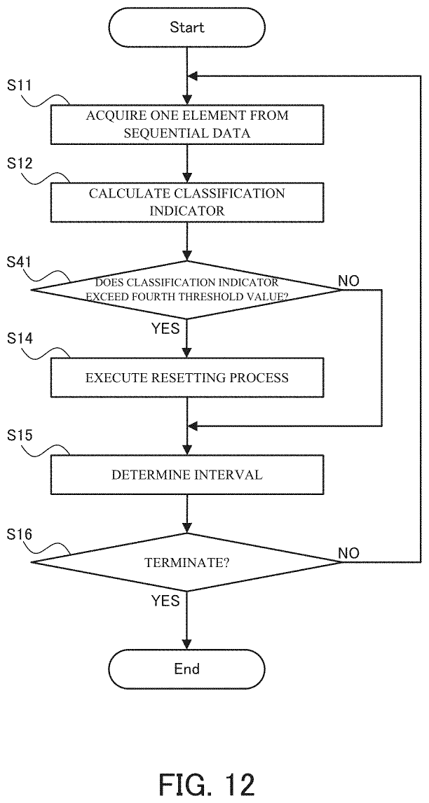

An information processing apparatus 10 according to a fourth embodiment is described with reference to FIGS. 12 to 14. Note that the fourth embodiment is different from the above-described first to third embodiments only in part of operation, and other operation and a system configuration may be similar to those of the first to third embodiments. Accordingly, in the following, the part different from the first to third embodiments is described in detail, and a description of other overlapping part is omitted as appropriate.

### (Flow of Operation)

First, a flow of operation of the information processing apparatus 10 according to the fourth embodiment is described with reference to FIG. 12. FIG. 12 is a flowchart showing the flow of the operation of the information processing apparatus according to the fourth embodiment. Note that in FIG. 12, processes similar to the processes shown in FIG. 3 are denoted by the same reference numbers as in FIG. 3.

As shown in FIG. 12, when the information processing apparatus 10 according to the fourth embodiment starts to operate, first, the acquisition unit 50 acquires one element from sequential data (step S11). The acquisition unit 50 outputs the acquired element of the sequential data to the indicator calculation unit 100. The indicator calculation unit 100 calculates a classification indicator, based on two or more elements thus acquired (step S12).

Subsequently, the process execution unit 200 determines whether or not the classification indicator calculated by the indicator calculation unit 100 exceeds a fourth threshold value (step S41). In other words, in the information processing apparatus 10 according to the fourth embodiment, it is set as a predetermined condition that the classification indicator exceeds the fourth threshold value. Note that the “fourth threshold value” is a threshold value to determine that the classification indicator greatly leans to the detection-target class side. For example, the fourth threshold value may be set as a value that can determine a state in which the classification indicator leans to the detection-target class side, further beyond a state in which the sequential data can be classified as the detection-target class. The fourth threshold value may be set to a value that is equal to the first threshold value or the second threshold value in the second embodiment.

When it is determined that the classification indicator exceeds the fourth threshold value (step S41: YES), the process execution unit 200 executes the process of resetting the classification indicator to the predetermined value (that is, the first process) (step S14). When it is determined that the classification indicator does not exceed the fourth threshold value (step S41: NO), the process execution unit 200 omits the process in step S14 (that is, the first process is not executed).

Subsequently, the interval determination unit 300 determines an interval, based on the classification indicator (step S15). Then, the information processing apparatus 10 according to the fourth embodiment determines whether or not to terminate the above-described series of processes (step S16). When it is determined to terminate the processes (step S16: YES), the series of processes is terminated. When it is determined not to terminate the processes (step S16: NO), the processes are started again from step S11.

### (Technical Effects)

Next, technical effects achieved by the information processing apparatus 10 according to the fourth embodiment are described.

As described in FIG. 12, in the information processing apparatus 10 according to the fourth embodiment, when the classification indicator exceeds the fourth threshold value, the first process (that is, the process of resetting the classification indicator to the predetermined value) is executed. With the configuration thus made, even if the classification indicator greatly leans to the detection-target class side, such a state can be resolved through the first process. Accordingly, when an interval including elements of the detection-target class comes to an end, the classification indicator smoothly changes to values on a side to a class other than the detection-target class. Accordingly, according to the information processing apparatus 10 in the fourth embodiment, an interval including elements of the detection-target class can be appropriately determined.

### (Modification of Fourth Embodiment)

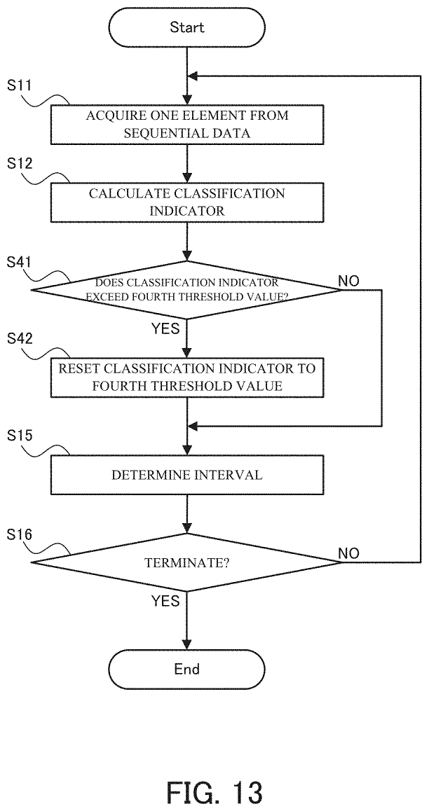

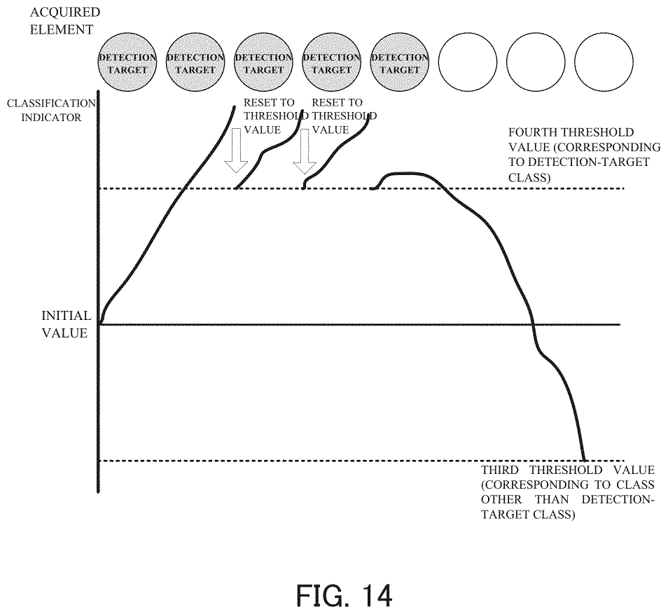

Next, an information processing apparatus 10 according to a modification of the fourth embodiment is described with reference to FIGS. 13 and 14. Note that the information processing apparatus 10 according to the modification of the fourth embodiment is different from the above-described fourth embodiment only in part of operation, and other operation and a system configuration may be similar to those of the fourth embodiment. Accordingly, in the following, the part different from the already described fourth embodiment is described in detail, and a description of other overlapping part is omitted as appropriate.

### (Flow of Operation)

First, a flow of operation of the information processing apparatus 10 according to the modification of the fourth embodiment is described with reference to FIG. 13. FIG. 13 is a flowchart showing the flow of the operation of the information processing apparatus according to the modification of the fourth embodiment. Note that in FIG. 13, processes similar to the processes shown in FIG. 12 are denoted by the same reference numbers as in FIG. 12.

As shown in FIG. 13, when the information processing apparatus 10 according to the modification of the fourth embodiment starts to operate, first, the acquisition unit 50 acquires one element from sequential data (step S11). The acquisition unit 50 outputs the acquired element of the sequential data to the indicator calculation unit 100. The indicator calculation unit 100 calculates a classification indicator, based on two or more elements thus acquired (step S12).

Subsequently, the process execution unit 200 determines whether or not the classification indicator calculated by the indicator calculation unit 100 exceeds the fourth threshold value (step S41). When it is determined that the classification indicator exceeds the fourth threshold value (step S41: YES), the process execution unit 200 executes the process of resetting the classification indicator to the fourth threshold value (step S42). In other words, in the modification of the fourth embodiment, the predetermined value is set to the fourth threshold value (that is, the threshold value on the detection-target class side). When it is determined that the classification indicator does not exceed the fourth threshold value (step S31: NO), the process execution unit 200 omits the process in step S42 (that is, the first process is not executed).

Subsequently, the interval determination unit 300 determines an interval, based on the classification indicator (step S15). Then, the information processing apparatus 10 according to the modification of the fourth embodiment determines whether or not to terminate the above-described series of processes (step S16). When it is determined to terminate the processes (step S16: YES), the series of processes is terminated. When it is determined not to terminate the processes (step S16: NO), the processes are started again from step S11.

### (Example of Changes in Classification Indicator)

Next, it is described specifically with reference to FIG. 14 how the classification indicator changes in the information processing apparatus 10 according to the modification of the fourth embodiment. FIG. 14 is a graph showing an example of changes in the classification indicator in the information processing apparatus according to the modification of the fourth embodiment.

In the example shown in FIG. 14, elements of the detection-target class are acquired first, and elements of a class other than the detection-target class are acquired thereafter. In such a case, the classification indicator changes first toward the fourth threshold value (that is, an upper side of the graph) corresponding to the detection-target class. However, when the classification indicator exceeds the fourth threshold value, the first process is executed, so that the classification indicator is reset to the fourth threshold value. Accordingly, in the example shown in FIG. 14, in an interval where elements of the detection-target class are consecutive, the classification indicator is reset to the fourth threshold value twice. Note that in the example shown in FIG. 14, although the classification indicator is reset a while after the fourth threshold value is exceeded, a configuration may be made such that the classification indicator is reset immediately after the fourth threshold value is exceeded. In such a case, the classification indicator is in a state as if the classification indicator sticks to the fourth threshold value.

Thereafter, when an element of the other class than the detection-target class starts to be acquired, the classification indicator changes toward the third threshold value (that is, a lower side of the graph) corresponding to the other class than the detection-target class. In such a situation, if the classification indicator went off the scale to the fourth threshold value side without being reset to the fourth threshold value, the classification indicator would take a long time to reach the third threshold value even in a state where elements of the other class than the detection-target class are acquired. Moreover, if an interval in which elements of the other class than the detection-target class are consecutive was relatively short, there would be a possibility that the classification indicator does not exceed the third threshold value even once. However, in the example shown in FIG. 14, since the classification indicator is reset to the fourth threshold value each time the classification indicator exceeds the fourth threshold value, the classification indicator reaches the third threshold value relatively early on.

### (Technical Effects)

Next, technical effects achieved by the information processing apparatus 10 according to the modification of the fourth embodiment are described.

As described in FIGS. 13 and 14, in the information processing apparatus 10 according to the modification of the fourth embodiment, when the classification indicator exceeds the fourth threshold value, the process of resetting the classification indicator to the fourth threshold value is executed. With the configuration thus made, when the classification indicator greatly leans to the detection-target class side, the classification indicator is set back to the fourth threshold value. When the classification indicator becomes the fourth threshold value, the situation in which the classification indicator greatly leans to the detection-target class side (for example, a situation in which the classification indicator goes off the scale to the detection-target class side) is reliably resolved. Accordingly, according to the information processing apparatus 10 in the modification of the fourth embodiment, an interval including elements of the detection-target class (particularly, an end point of the interval) can be appropriately determined.

### Fifth Embodiment

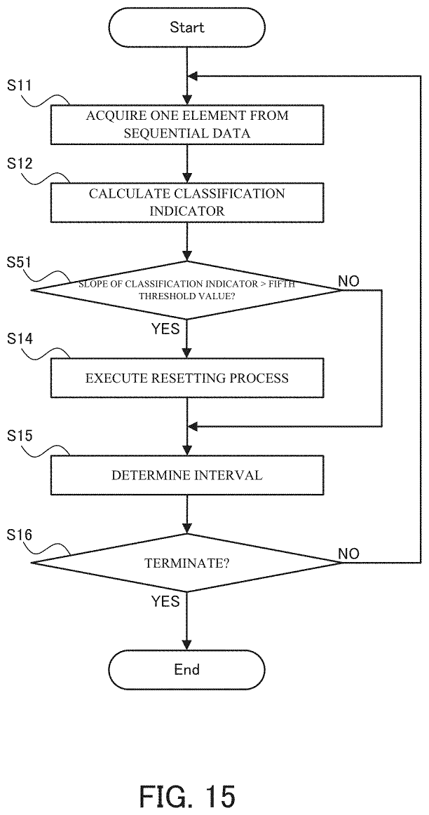

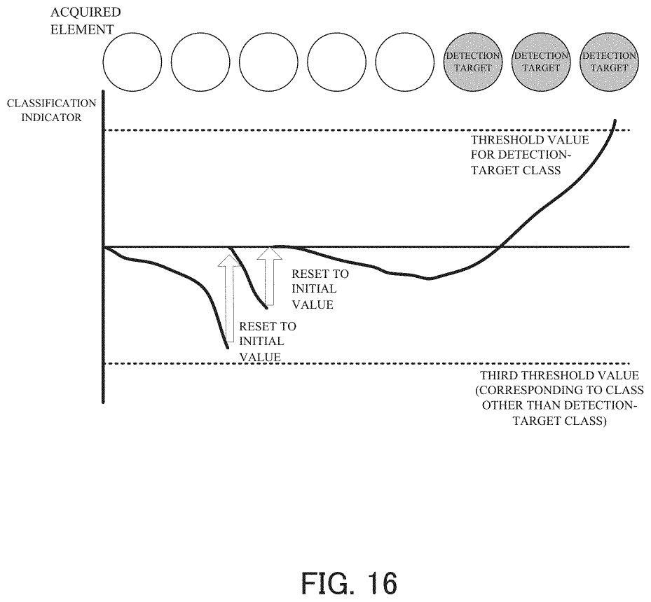

An information processing apparatus 10 according to a fifth embodiment is described with reference to FIGS. 15 and 16. Note that the fifth embodiment is different from the above-described first to fourth embodiments only in part of operation, and other operation and a system configuration may be similar to those of the first to fourth embodiments. Accordingly, in the following, the part different from the first to fourth embodiments is described in detail, and a description of other overlapping part is omitted as appropriate.

### (Flow of Operation)

First, a flow of operation of the information processing apparatus 10 according to the fifth embodiment is described with reference to FIG. 15. FIG. 15 is a flowchart showing the flow of the operation of the information processing apparatus according to the fifth embodiment. Note that in FIG. 15, processes similar to the processes shown in FIG. 3 are denoted by the same reference numbers as in FIG. 3.

As shown in FIG. 15, when the information processing apparatus 10 according to the fifth embodiment starts to operate, first, the acquisition unit 50 acquires one element from sequential data (step S11). The acquisition unit 50 outputs the acquired element of the sequential data to the indicator calculation unit 100. The indicator calculation unit 100 calculates a classification indicator, based on two or more elements thus acquired (step S12).

Subsequently, the process execution unit 200 determines whether or not a slope of the classification indicator calculated by the indicator calculation unit 100 exceeds a fifth threshold value (step S51). In other words, in the information processing apparatus 10 according to the fifth embodiment, it is set as a predetermined condition that the slope (in other words, a rate of change) of the classification indicator exceeds the fifth threshold value. Note that the “fifth threshold value” is a threshold value to determine that the classification indicator sharply changes. For example, the fifth threshold value may be set as a value that can determine that bias will occur in the classification indicator if the classification indicator changes with an existing slope.

When it is determined that the slope of the classification indicator exceeds the fifth threshold value (step S51: YES), the process execution unit 200 executes the process of resetting the classification indicator to the predetermined value (that is, the first process) (step S14). When it is determined that the slope of the classification indicator does not exceed the fifth threshold value (step S51: NO), the process execution unit 200 omits the process in step S14 (that is, the first process is not executed).

Subsequently, the interval determination unit 300 determines an interval, based on the classification indicator (step S15). Then, the information processing apparatus 10 according to the fifth embodiment determines whether or not to terminate the above-described series of processes (step S16). When it is determined to terminate the processes (step S16: YES), the series of processes is terminated. When it is determined not to terminate the processes (step S16: NO), the processes are started again from step S11.

### (Example of Changes in Classification Indicator)

Next, it is described specifically with reference to FIG. 16 how the classification indicator changes in the information processing apparatus 10 according to the fifth embodiment. FIG. 16 is a graph showing an example of changes in the classification indicator in the information processing apparatus according to the fifth embodiment.

In the example shown in FIG. 16, elements of a class other than the detection-target class are acquired first, and elements of the detection-target class are acquired thereafter. In such a case, the classification indicator changes first toward the third threshold value (that is, a lower side of the graph) corresponding to the other class than the detection-target class. However, in the example shown in FIG. 16, the first process is not performed for some time because the slope of the classification indicator is relatively gentle in a first stage. The first process for a first time is executed at a stage where the slope of the classification indicator that has been relatively gentle suddenly becomes steep. Note that the slope of the classification indicator remains steep also after the first process for the first time. Accordingly, the first process for a second time is executed relatively early on, compared to the first process for the first time.

Thereafter, when an element of the detection-target class starts to be acquired, the classification indicator changes toward the threshold value for the detection-target class (for example, the first threshold value or the second threshold value in the second embodiment). In such a situation, if the classification indicator greatly leaned to the third threshold value side without being reset to the initial value, the classification indicator would take a long time to exceed the threshold value for the detection-target class even in a state where elements of the detection-target class are acquired. Moreover, if an interval in which elements of the detection-target class are consecutive was relatively short, there would be a possibility that the classification indicator does not exceed the threshold value for the detection-target class even once. However, in the example shown in FIG. 16, since the classification indicator is reset to the predetermined value each time the slope of the classification indicator exceeds the fifth threshold value, the classification indicator exceeds the threshold value for the detection-target class relatively early on.

Moreover, the process execution unit 200 may be configured to reset the classification indicator to the initial value when the slope of the classification indicator changes from down toward the third threshold value to up toward the detection-target class side. More specifically, when elements of the detection-target class are acquired and such elements are reflected in the calculation of the classification indicator, the classification indicator that has changed toward the third threshold value is inverted to change toward the detection-target class side. The process execution unit 200 may be configured to reset the classification indicator to the initial value at such a point of change of the slope (for example, a point where positive/negative of the slope is inverted, or a point where the slope becomes zero).

Note that in the above-described example, when the slope of the classification indicator toward the third threshold value (that is, the side to the other class than the detection-target class) exceeds the fifth threshold value, the process execution unit 200 resets the classification indicator to the initial value that is the predetermined value, that is, executes the first process as in the third embodiment. In the information processing apparatus 10 according to the fifth embodiment, in addition to or in place of such a first process, the process execution unit 200 may execute the process of resetting the classification indicator when the slope of the classification indicator toward the fourth threshold value (that is, the detection-target class side) exceeds the fifth threshold value. In other words, the first process as in the fourth embodiment may be executed.

### (Technical Effects)

Next, technical effects achieved by the information processing apparatus 10 according to the fifth embodiment are described.

As described in FIGS. 15 and 16, in the information processing apparatus 10 according to the fifth embodiment, when the slope of the classification indicator exceeds the fifth threshold value, the first process (that is, the process of resetting the classification indicator to the predetermined value) is executed. With the configuration thus made, even if the classification indicator greatly changes to a specific class side, bias in the classification indicator can be resolved through the first process. In other words, bias occurring due to a sharp change in the classification indicator can be prevented. Accordingly, according to the information processing apparatus 10 in the fifth embodiment, an interval including elements of the detection-target class can be appropriately determined.

### Sixth Embodiment

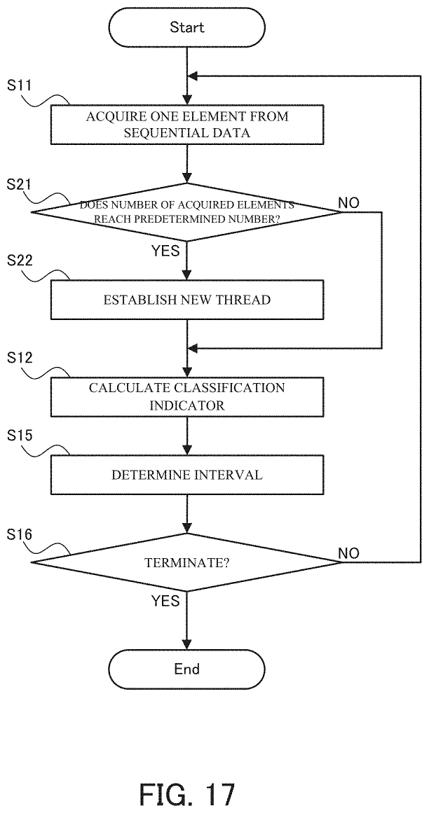

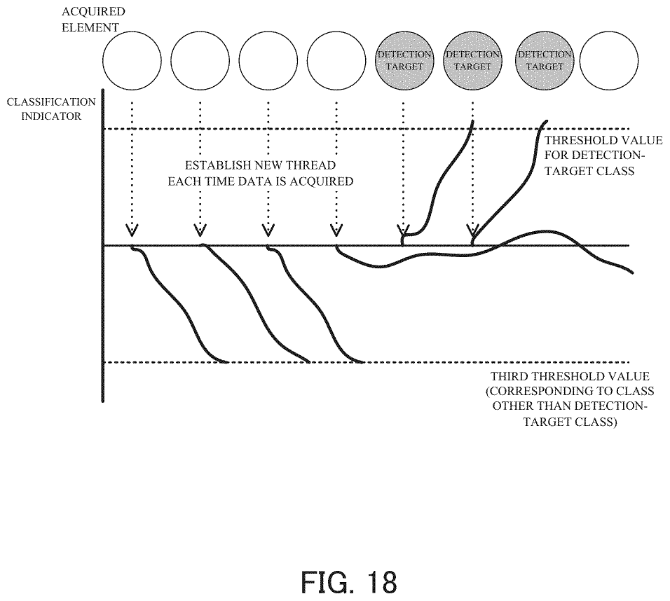

An information processing apparatus 10 according to a sixth embodiment is described with reference to FIGS. 17 and 18. Note that the sixth embodiment is different from the above-described first to fifth embodiments only in part of operation, and other operation and a system configuration may be similar to those of the first to fifth embodiments. Accordingly, in the following, the part different from the first to fifth embodiments is described in detail, and a description of other overlapping part is omitted as appropriate.

### (Flow of Operation)

First, a flow of operation of the information processing apparatus 10 according to the sixth embodiment is described with reference to FIG. 17. FIG. 17 is a flowchart showing the flow of the operation of the information processing apparatus according to the sixth embodiment. Note that in FIG. 17, processes similar to the processes shown in FIG. 4 are denoted by the same reference numbers as in FIG. 4.

As shown in FIG. 17, when the information processing apparatus 10 according to the sixth embodiment starts to operate, first, the acquisition unit 50 acquires one element from sequential data (step S11). Subsequently, the process execution unit 200 determines whether or not the number of elements acquired by the acquisition unit 50 reaches a predetermined number (step S21). When it is determined that the number of acquired elements reaches the predetermined number (step S21: YES), the process execution unit 200 executes the process of establishing a new thread to calculate the classification indicator (that is, the second process) (step S22). When it is determined that the number of acquired elements does not reach the predetermined number (step S21: NO), the process execution unit 200 omits the process in step S22 (that is, the second process is not executed). Note that the process execution unit 200 initializes a count of the number of acquired elements (for example, sets the count to zero) each time the number of acquired elements reaches the predetermined number. As a result, the process execution unit 200 executes the second process each time the predetermined number of elements are acquired by the acquisition unit.

Note that in a case where the predetermined number is set to “1”, the condition in step S21 is satisfied when one element is acquired in step S11. Accordingly, when the predetermined number is “1”, the determination process in step S21 can be omitted. In such a case, since the condition that the predetermined number of elements are acquired is substantially unrequired (that is, the second process is executed each time), operation is similar to the operation in the first embodiment (see FIG. 4).

Subsequently, the indicator calculation unit 100 calculates a classification indicator, based on two or more acquired elements (step S12). When the second process is executed by the process execution unit 200 (in other words, when the number of acquired elements reaches the predetermined number), the indicator calculation unit 100 calculates the classification indicator based on a newly established thread. When the second process is not executed by the process execution unit 200 (in other words, when the number of acquired elements does not reach the predetermined number), the classification indicator is calculated based on the same thread as previous.

Subsequently, the interval determination unit 300 determines an interval, based on the classification indicator (step S15). Then, the information processing apparatus 10 according to the sixth embodiment determines whether or not to terminate the above-described series of processes (step S16). When it is determined to terminate the processes (step S16: YES), the series of processes is terminated. When it is determined not to terminate the processes (step S16: NO), the processes are started again from step S11.

### (Example of Changes in Classification Indicator)

Next, it is described specifically with reference to FIG. 18 how the classification indicator changes in the information processing apparatus 10 according to the sixth embodiment. FIG. 18 is a graph showing an example of changes in the classification indicator in the information processing apparatus according to the sixth embodiment. Note that in the following, a case in which the predetermined number is “1” is taken as an example.

In the example shown in FIG. 18, elements of a class other than the detection-target class are acquired first, and elements of the detection-target class are acquired thereafter only in a relatively short interval. In such a case, the classification indicator changes first toward the third threshold value (that is, a lower side of the graph) corresponding to the other class than the detection-target class. However, in the example shown in FIG. 18, since a new thread is established each time one element is acquired, the classification indicator changes from the initial value each time one element is acquired.

Thereafter, when an element of the detection-target class starts to be acquired, the classification indicator changes toward the threshold value for the detection-target class (for example, the first threshold value or the second threshold value in the second embodiment). In such a situation, if the classification indicator greatly leaned to the third threshold value side without a new thread being established, the classification indicator would take a long time to exceed the threshold value for the detection-target class even in a state where elements of the detection-target class are acquired. Moreover, if an interval in which elements of the detection-target class are consecutive was short, there would be a possibility that the classification indicator does not exceed the threshold value for the detection-target class even once. However, in the example shown in FIG. 18, since a new thread is established each time one element is acquired, the classification indicator exceeds the threshold value for the detection-target class relatively early on.

### (Technical Effects)

Next, technical effects achieved by the information processing apparatus 10 according to the sixth embodiment are described.

As described in FIGS. 17 and 18, in the information processing apparatus 10 according to the sixth embodiment, the second process (that is, the process of establishing a new thread) is executed each time the predetermined number of elements are acquired. With the configuration thus made, since the classification indicator is calculated afresh each time the predetermined number of elements are acquired, bias in the classification indicator can be prevented from occurring under the influence of previous results of the calculation. Accordingly, according to the information processing apparatus 10 in the sixth embodiment, an interval including elements of the detection-target class can be appropriately determined.

The example shown in FIG. 18 is described on the premise that the predetermined number is set to “1”. However, for example, when the predetermined number is set to “2”, a new thread is established once every two times. If the frequency of establishing a new thread is reduced in such a manner, a reasonable effect of preventing bias in the classification indicator can be brought about while an increase in a load of the calculation process can be restrained.

### Seventh Embodiment

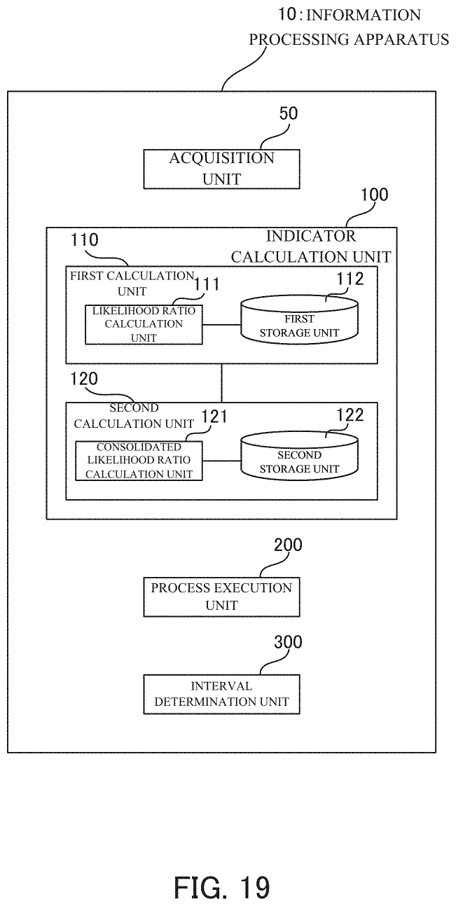

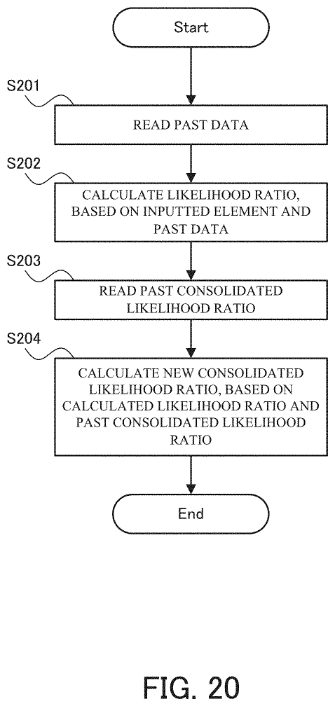

An information processing apparatus 10 according to a seventh embodiment is described with reference to FIGS. 19 and 20. Note that the seventh embodiment is different from the above-described first to sixth embodiments in part of a configuration and operation, and, for example, a hardware configuration and a flow of entire operation may be similar to those of the first to sixth embodiments. Accordingly, in the following, the part different from the above-described first to sixth embodiments is described in detail, and a description of other overlapping part is omitted as appropriate.

### (Functional Configuration)

First, a functional configuration of the information processing apparatus 10 according to the seventh embodiment is described with reference to FIG. 19. FIG. 19 is a block diagram showing the function configuration of the information processing apparatus according to the seventh embodiment. Note that in FIG. 19, elements similar to the constitutional elements shown in FIG. 2 are denoted by the same reference numbers as in FIG. 2.

As shown in FIG. 19, the information processing apparatus 10 according to the seventh embodiment includes, as processing blocks for implementing functions of the information processing apparatus 10, an acquisition unit 50, an indicator calculation unit 100, a process execution unit 200, and an interval determination unit 300. In the seventh embodiment, the indicator calculation unit 100 in particular includes a first calculation unit 110 and a second calculation unit 120. The first calculation unit 110 includes a likelihood ratio calculation unit 111 and a first storage unit 112. The second calculation unit 120 includes a consolidated likelihood ratio calculation unit 121 and a second storage unit 122. Note that each of the likelihood ratio calculation unit 111 and the consolidated likelihood ratio calculation unit 121 may be implemented by the above-described processor 11 (see FIG. 1). Moreover, each of the first storage unit 112 and the second storage unit 122 may be implemented by the above-described storage device 14 (see FIG. 1).

The likelihood ratio calculation unit 111 is configured to be able to calculate a likelihood ratio for each element acquired by the acquisition unit 50. The likelihood ratio is a value indicating a likelihood of each element belonging to a class of a plurality of classes. The likelihood ratio calculation unit 111 calculates the likelihood ratio, based on an acquired element and past data stored in the first storage unit 112. Information stored in the first storage unit 112 is configured to be able to be read by the likelihood ratio calculation unit 111. When the first storage unit 112 stores a past likelihood ratio, the likelihood ratio calculation unit 111 may calculate a likelihood ratio for an acquired element by reading the stored past likelihood ratio. In contrast, when the first storage unit 112 stores an element acquired in the past, the likelihood ratio calculation unit 111 may calculate a likelihood ratio for an acquired element by calculating a past likelihood ratio from the stored past element. In the following, a specific example of the likelihood ratio is described.

It is assumed that N elements included in sequential data are x₁, . . . x_{N}, and that a plurality of classes are R, F. In other words, for simplicity, 2-class classification, in which the number of classes is two, is assumed in the present example. Here, a result of calculating a probability that an element xᵢ belongs to the class R, without taking past data into consideration, is represented by p(R|xᵢ). Moreover, a result of calculating a probability that the element x, belongs to the class F, without taking past data into consideration, is represented by p(F|xᵢ). At the time, a likelihood ratio between the probabilities is expressed as in a following expression (1).

$$[ Expression 1 ]$$

$$\frac{p ( R \vert {x}_{i} )}{p ( F \vert {x}_{i} )} \qquad ( 1 )$$

The likelihood ratio in the expression (1) indicates a ratio between likelihoods that are the probability that the element xᵢ belongs to the class R and the probability that the element xᵢ belongs to the class F. For example, when the likelihood ratio exceeds one, the element xᵢ may be classified as the class R, rather than the class F, because p(R|xᵢ)>p(F|xᵢ). As described above, the likelihood ratio in the expression (1) functions as an indicator indicating which one of the class R and the class F an inputted element belongs to.

The likelihood ratio calculation unit 111 can perform calculation by taking a plurality of elements (that is, relevance between an inputted element and past data) into consideration as described above. In such a case, for example, a likelihood ratio calculated by taking two elements xᵢ, xᵢ₋₁ into consideration is expressed as in a following expression (2).

$$[ Expression 2 ]$$

$$\frac{p ( R \vert {x}_{i} , {x}_{i - 1} )}{p ( F \vert {x}_{i} , {x}_{i - 1} )} \qquad ( 2 )$$

The consolidated likelihood ratio calculation unit 121 is configured to be able to calculate a consolidated likelihood ratio that is a classification indicator. The consolidated likelihood ratio is a value indicating a likelihood of sequential data belonging to a class of a plurality of classes. The consolidated likelihood ratio calculation unit 121 calculates the consolidated likelihood ratio by using a likelihood ratio calculated by the likelihood ratio calculation unit 111 and a past consolidated likelihood ratio stored in the second storage unit 122. Information (that is, the past consolidated likelihood ratio) stored in the second storage unit 122 is configured to be able to be read by the consolidated likelihood ratio calculation unit 121. In the following, a specific example of the consolidated likelihood ratio is described. Note that a case of 2-class classification, in which the number of classes is two, is described, similarly to the description of the likelihood ratio given above.

When N elements are inputted at a point of time of calculating a consolidated likelihood ratio, the N elements are denoted by x₁, . . . , x_{N}. Here, a probability that the entire sequential data belongs to the class R is represented by p(x₁, . . . , x_{N}|R). Moreover, a probability that the entire sequential data belongs to the class F is represented by p(x₁, . . . , x_{N}|F). In such a case, a likelihood ratio between the probabilities is expressed by a following expression (3). The expression (3) is referred to as a consolidated likelihood ratio.

$$[ Expression 3 ]$$

$$\frac{p ( {x}_{1} , … , {x}_{N} \vert R )}{p ( {x}_{1} , … , {x}_{N} \vert F )} \qquad ( 3 )$$

When it is assumed that each element of the sequential data is independent of each other, the consolidated likelihood ratio can be calculated by being broken down into terms for the individual elements as in a following expression (4).

$$[ Expression 4 ]$$

$$log [ \frac{p ( {x}_{1} , … , {x}_{N} \vert R )}{p ( {x}_{1} , … , {x}_{N} \vert F )} ] = {\sum }_{i = 1}^{N} log [ \frac{p ( R \vert {x}_{i} )}{p ( F \vert {x}_{i} )} ] \qquad ( 4 )$$

In the expression (4), although a logarithm of the likelihood ratio is used for breaking-down into a sum of the terms for the individual elements to simplify the calculation, such formulation is not essential. Note that in the following, the term “likelihood ratio” or “consolidated likelihood ratio” is also used for such a logarithmic likelihood ratio in some cases. Moreover, although presentation of a base of the logarithm is omitted, the base may take an arbitrary value.

However, the assumption that each element is independent of each other does not hold true in many cases because, as described above, the likelihood ratio and the consolidated likelihood ratio are calculated by taking two or more elements into consideration in the present embodiment. Accordingly, breaking-down into terms for each individual elements as in the expression (4) is impossible, and the consolidated likelihood ratio is calculated by using different calculation expressions, depending on the number of elements between which relevance is taken into consideration.

For example, when two elements, namely, an element and an immediately preceding element, are taken into consideration, the consolidated likelihood ratio can be calculated by using a following expression (5).

$$[ Expression 5 ]$$

$$log [ \frac{p ( {x}_{1} , … , {x}_{N} \vert R )}{p ( {x}_{1} , … , {x}_{N} \vert F )} ] = {\sum }_{i = 2}^{N} log [ \frac{p ( R \vert {x}_{i} , {x}_{i - 1} )}{p ( F \vert {x}_{i} , {x}_{i - 1} )} ] - {\sum }_{i = 2}^{N - 1} log [ \frac{p ( R \vert {x}_{i} )}{p ( F \vert {x}_{i} )} ] \qquad ( 5 )$$

### (Flow of Indicator Calculation Process)

Next, a flow of an indicator calculation process (that is, a process of calculating the likelihood ratio and the consolidated likelihood ratio) in the information processing apparatus 10 according to the seventh embodiment is described with reference to FIG. 20. FIG. 20 is a flowchart showing the flow of the indicator calculation process in the information processing apparatus according to the seventh embodiment.

As shown in FIG. 20, in the indicator calculation process according to the seventh embodiment, first, the likelihood ratio calculation unit 111 of the first calculation unit 110 reads past data from the first storage unit 112 (step S201). For example, the past data may be a result of the process executed by the likelihood ratio calculation unit 111 for an element acquired immediately prior to (in other words, a likelihood ratio calculated for an element immediately prior to) an element acquired by the acquisition unit 50 for a current time. Alternatively, the past data may be the element itself acquired immediately prior to the element acquired by the acquisition unit 50 for the current time.

Subsequently, the likelihood ratio calculation unit 111 calculates a new likelihood ratio (that is, a likelihood ratio for the element acquired by the acquisition unit 50 for the current time), based on the element acquired by the acquisition unit 50 and the past data read from the first storage unit 112 (step S202). The likelihood ratio calculation unit 111 outputs the calculated likelihood ratio to the second calculation unit 120. The likelihood ratio calculation unit 111 may store the calculated likelihood ratio in the first storage unit 112.

Subsequently, the consolidated likelihood ratio calculation unit 121 of the second calculation unit 120 reads a past consolidated likelihood ratio from the second storage unit 122 (step S203). For example, the past consolidated likelihood ratio may be a result of the process executed by the consolidated likelihood ratio calculation unit 121 for the element acquired immediately prior to (in other words, a consolidated likelihood ratio calculated for the element immediately prior to) the element acquired by the acquisition unit 50 for the current time.

Subsequently, the consolidated likelihood ratio calculation unit 121 calculates a new consolidated likelihood ratio (that is, a consolidated likelihood ratio for the element acquired by the acquisition unit 50 for the current time), based on the likelihood ratio calculated by the likelihood ratio calculation unit 111 and the past consolidated likelihood ratio read from the second storage unit 122 (step S204). The consolidated likelihood ratio calculation unit 121 outputs the calculated consolidated likelihood ratio to the process execution unit 200 and the interval determination unit 300. The consolidated likelihood ratio calculation unit 121 may store the calculated consolidated likelihood ratio in the second storage unit 122.

### (Technical Effects)

Next, technical effects achieved by the information processing apparatus 10 according to the seventh embodiment are described.

In the information processing apparatus 10 according to the seventh embodiment, a likelihood ratio and a consolidated likelihood ratio are calculated from elements included in sequential data. The calculated consolidated likelihood ratio is used for a classification indicator. As described already, the likelihood ratio is a value indicating a likelihood that each of a plurality of elements belongs to a class of a plurality of classes. The consolidated likelihood ratio calculated from the likelihood ratios is a value indicating a likelihood that the sequential data belongs to a class of the plurality of classes. Accordingly, if the consolidated likelihood ratio is used for a classification indicator, an interval including elements of the detection-target class can be appropriately determined.

### Eighth Embodiment

An information processing apparatus according to an eighth embodiment is described. Note that the eighth embodiment is to describe specific examples of application of the information processing apparatus according to any of the above-described first to seventh embodiments, and a system configuration and a flow of operation may be similar to those of the first to seventh embodiments. Accordingly, in the following, part different from the first to seventh embodiments is described in detail, and a description of other overlapping part is omitted as appropriate.

### (Detection of Cancer Cells)

In the present example, classes relate to normal (positive) and abnormal (negative) states of cells (an object).

The information processing apparatus 10 according to the eighth embodiment may be configured to function as a system that detects cancer cells included in normal cells. In this case, the information processing apparatus 10 may be configured to detect a cancer cell as an element of a detection-target class. With the configuration thus made, an interval including cancer cells can be appropriately determined.

### (Detection of Engine Sound)

In the present example, classes relate to presence and absence of a specific noise (attribute) of engine sound (an object).

The information processing apparatus 10 according to the eighth embodiment may be configured to function as a system that extracts a specific engine sound included in a plurality of types of engine sound. In this case, the information processing apparatus 10 may be configured to detect the specific engine sound as an element of a detection-target class. With the configuration thus made, an interval including the specific engine sound can be appropriately determined.

### (Detection of Fake Video)

In the present example, a class indicates whether a face (an object) of a person is real (true) or fake (false).

The information processing apparatus 10 according to the eighth embodiment may be configured to function as a system that detects a fake video (for example, a fictitious video produced by a synthesis process or the like). In this case, the information processing apparatus 10 may be configured to detect a synthesized area (that is, an area added to an original video) as an element of a detection-target class. With the configuration thus made, it can be easily determined whether or not a video is a fake video.

### (Detection of Smile)

The information processing apparatus 10 according to the eighth embodiment may be configured to function as a system that detects a smile in a video or an image. In this case, the information processing apparatus 10 may be configured to detect an area (for example, eyes or a mouth) presenting a characteristic of a smile as an element of a detection-target class. With the configuration thus made, a smile included in a video or an image can be easily detected.

### (Detection of Feeling)

By applying the above-described detection of a smile, the information processing apparatus 10 according to the eighth embodiment may be configured to function as a system that determines a feeling of a person. In this case, the information processing apparatus 10 may be configured to detect, from an image, an area (for example, eyes or a mouth) presenting a characteristic of each of a delighted expression, a feeling of sadness, a feeling of anger, and the like as an element of a detection-target class. Alternatively, the information processing apparatus 10 may detect a feeling from voice of a person, as another element of the detection-target class. With the configuration thus made, a feeling of a person included in a video or an image can be determined.

### (Detection of Ball Impact)

The information processing apparatus 10 according to the eighth embodiment may be configured to function as a system that detects a moment of ball impact in a video of, for example, tennis or the like. In this case, the information processing apparatus 10 may be configured to detect an area presenting a characteristic of ball impact (for example, a compressed ball, a degree of deflection of strings, or the like) as an element of a detection-target class. With the configuration thus made, a moment of ball impact can be appropriately detected.

### Supplementary Notes

The above-described embodiments can also be further described as, but are not limited to, the following supplements.

### (Supplementary Note 1)

An information processing apparatus described in Supplementary Note 1 is an information processing apparatus including: an acquisition unit configured to sequentially acquire a plurality of elements included in sequential data; a calculation unit configured to calculate, based on at least two elements of the plurality of elements, a classification indicator indicating which one of a plurality of classes the sequential data belongs to; a processing unit configured to execute either a first process of resetting the classification indicator to a predetermined value when a predetermined condition is satisfied, or a second process of establishing a new thread to calculate the classification indicator; and a determination unit configured to determine an interval including an element of a detection-target class in the sequential data, based on the classification indicator.

### (Supplementary Note 2)

An information processing apparatus described in Supplementary Note 2 is the information processing apparatus described in Supplementary Note 1, wherein the determination unit is configured to determine that interval is the interval including an element of the detection-target class when the classification indicator exceeds a first threshold value, and to determine that interval ceases to be the interval including an element of the detection-target class when the classification indicator falls below a second threshold value after the classification indicator exceeds the first threshold value.

### (Supplementary Note 3)

An information processing apparatus described in Supplementary Note 3 is the information processing apparatus described in Supplementary Note 1 or 2, wherein the predetermined condition is that the classification indicator crosses a threshold value corresponding to any one class.

### (Supplementary Note 4)

An information processing apparatus described in Supplementary Note 4 is the information processing apparatus described in Supplementary Note 3, wherein the predetermined condition is that the classification indicator crosses a threshold value corresponding to a class other than the detection-target class.

### (Supplementary Note 5)

An information processing apparatus described in Supplementary Note 5 is the information processing apparatus described in Supplementary Note 4, wherein the predetermined value is an initial value of the classification indicator.

### (Supplementary Note 6)

An information processing apparatus described in Supplementary Note 6 is the information processing apparatus described in any one of Supplementary Notes 3 to 5, wherein the predetermined condition is that the classification indicator exceeds a fourth threshold value corresponding to the detection-target class.

### (Supplementary Note 7)

An information processing apparatus described in Supplementary Note 7 is the information processing apparatus described in Supplementary Note 6,wherein the predetermined value is the fourth threshold value.

### (Supplementary Note 8)

An information processing apparatus described in Supplementary Note 8 is the information processing apparatus described in any one of Supplementary Notes 1 to 7, wherein the predetermined condition is that a slope of the classification indicator exceeds a fifth threshold value.

### (Supplementary Note 9)

An information processing apparatus described in Supplementary Note 9 is the information processing apparatus described in any one of Supplementary Notes 1 to 8, wherein the predetermined condition is that a predetermined number of elements are acquired.

### (Supplementary Note 10)

An information processing apparatus described in Supplementary Note 10 is the information processing apparatus described in any on of Supplementary Notes 1 to 9, wherein the calculation unit includes, a first calculation unit configured to calculate a likelihood ratio indicating a likelihood that each of the plurality of elements belongs to a class of the plurality of classes, and a second calculation unit configured to calculate, as the classification indicator, a consolidated likelihood ratio indicating a likelihood that the sequential data belongs to a class of the plurality of classes, based on the likelihood ratios.

### (Supplementary Note 11)

An information processing method described in Supplementary Note 11 is an information processing method including: sequentially acquiring a plurality of elements included in sequential data; calculating, based on at least two elements of the plurality of elements, a classification indicator indicating which one of a plurality of classes the sequential data belongs to; executing either a first process of resetting the classification indicator to a predetermined value when a predetermined condition is satisfied, or a second process of establishing a new thread to calculate the classification indicator; and determining an interval including an element of a detection-target class in the sequential data, based on the classification indicator.

### (Supplementary Note 12)

A computer program described in Supplementary Note 12 is a computer program that allows a computer to: sequentially acquire a plurality of elements included in sequential data; calculate, based on at least two elements of the plurality of elements, a classification indicator indicating which one of a plurality of classes the sequential data belongs to; execute either a first process of resetting the classification indicator to a predetermined value when a predetermined condition is satisfied, or a second process of establishing a new thread to calculate the classification indicator; and determine an interval including an element of a detection-target class in the sequential data, based on the classification indicator.

### (Supplementary Note 13)

A recording medium described in Supplementary Note 13 is a recording medium on which the computer program described in Supplementary Note 12 is recorded.

Changes can be made to the present disclosure as appropriate within a scope that does not conflict with the gist or the principle of the invention that can be read from the claims and the specification in its entirety, and an information processing apparatus, an information processing method, and a computer program with such changes are also incorporated within the technical idea of the present disclosure.

### DESCRIPTION OF REFERENCE CODES

10 Information processing apparatus

11 Processor

14 Storage device

50 Acquisition unit

110 First calculation unit

111 Likelihood ratio calculation unit

112 First storage unit

120 Second calculation unit

121 Consolidated likelihood ratio calculation unit

122 Second storage unit

200 Process execution unit

300 Interval determination unit

What is claimed is:

1. An information processing apparatus comprising:
at least one memory configured to store instructions; and
at least one processor configured to execute the instructions to:
sequentially acquire a plurality of elements included in sequential data;
calculate, based on at least two elements of the plurality of elements, a classification indicator indicating which one of a plurality of classes the sequential data belongs to;
execute either a first process of resetting the classification indicator to a predetermined value when a predetermined condition is satisfied, or a second process of establishing a new thread to calculate the classification indicator; and
determine an interval including an element of a detection-target class in the sequential data, based on the classification indicator.

2. The information processing apparatus according to claim 1, wherein the at least one processor is configured to execute the instructions to determine that interval is the interval including an element of the detection-target class when the classification indicator exceeds a first threshold value, and to determine that interval ceases to be the interval including an element of the detection-target class when the classification indicator falls below a second threshold value after the classification indicator exceeds the first threshold value.

3. The information processing apparatus according to claim 1 or 2, wherein the predetermined condition is that the classification indicator crosses a threshold value corresponding to any one class.

4. The information processing apparatus according to claim 3, wherein the predetermined condition is that the classification indicator crosses a threshold value corresponding to a class other than the detection-target class.

5. The information processing apparatus according to claim 4, wherein the predetermined value is an initial value of the classification indicator.

6. The information processing apparatus according to claim 3, to 5, wherein the predetermined condition is that the classification indicator exceeds a fourth threshold value corresponding to the detection-target class.

7. The information processing apparatus according to claim 6, wherein the predetermined value is the fourth threshold value.

8. The information processing apparatus according to claim 1, to 7, wherein the predetermined condition is that a slope of the classification indicator exceeds a fifth threshold value.

9. The information processing apparatus according to claim 1, wherein the predetermined condition is that a predetermined number of elements are acquired.

10. The information processing apparatus according to claim 1, wherein the at least one processor is further configured to execute the instructions to
calculate a likelihood ratio indicating a likelihood that each of the plurality of elements belongs to a class of the plurality of classes, and
calculate, as the classification indicator, a consolidated likelihood ratio indicating a likelihood that the sequential data belongs to a class of the plurality of classes, based on the likelihood ratios.

11. An information processing method comprising:
sequentially acquiring a plurality of elements included in sequential data;
calculating, based on at least two elements of the plurality of elements, a classification indicator indicating which one of a plurality of classes the sequential data belongs to;
executing either a first process of resetting the classification indicator to a predetermined value when a predetermined condition is satisfied, or a second process of establishing a new thread to calculate the classification indicator; and
determining an interval including an element of a detection-target class in the sequential data, based on the classification indicator.

12. A non-transitory recording medium on which a computer program is recorded, the computer program allowing a computer to:
sequentially acquire a plurality of elements included in sequential data;
calculate, based on at least two elements of the plurality of elements, a classification indicator indicating which one of a plurality of classes the sequential data belongs to;
execute either a first process of resetting the classification indicator to a predetermined value when a predetermined condition is satisfied, or a second process of establishing a new thread to calculate the classification indicator; and
determine an interval including an element of a detection-target class in the sequential data, based on the classification indicator.
